(19) United States
(12) Patent Application Publication
(10) Pub. No.: US 2019/0178328 A1
(43) Pub. Date: Jun. 13, 2019

(54) SPRING SLEEVE, CYLINDER, PISTON CYLINDER UNIT AND METHOD OF MANUFACTURING A PISTON CYLINDER UNIT

(71) Applicant: STABILUS GmbH, Koblenz (DE)

(72) Inventor: Michael Schneider, Ochterdung (DE)

(21) Appl. No.: 16/211,565

(22) Filed: Dec. 6, 2018

(30) Foreign Application Priority Data
Dec. 12, 2017 (DE) 10 2017 129 539.9

(51) Int. Cl. F16F 9/38; F16F 1/02; F16F 9/32; F16F 13/00; C08G 69/00; C08L 77/00; C08K 7/06; C08K 3/04; C08K 7/14; C08K 3/40

(52) U.S. Cl. CPC F16F 9/38; B29D 23/00; F16F 9/3235; F16F 13/007; F16F 9/3278; C08G 69/00; C08L 77/00; C08K 7/06; C08K 3/04; C08K 7/14; C08K 3/40; F16F 2224/0241; F16F 2226/04; F16F 13/002; F16F 2226/02; F16F 2230/0023; F16F 2230/0058; F16F 2230/04; F16F 2230/10; F16F 1/024

(57) ABSTRACT

Provided is a spring sleeve for a piston cylinder unit, wherein the spring sleeve is adapted to receive a spring, at least partially, and to guide it, wherein the spring sleeve has a cylindrical sleeve inner surface. The embodiment further relates to a cylinder for a piston cylinder unit, wherein the cylinder) is adapted to be arranged inside a spring of a piston cylinder unit. The embodiment also relates to a piston cylinder unit, including a cylinder, a spring arranged concentrically around the cylinder, and an inner spring sleeve and outer spring sleeve each arranged concentrically around the spring, wherein the cylinder and the spring are arranged inside the inner spring sleeve and the outer spring sleeve. Finally, the embodiment relates to a method of manufacturing such a piston cylinder unit.

### CROSS-REFERENCE TO RELATED APPLICATION

This application claims priority to German Application No. 10 2017 129 539.9, having a filing date of Dec. 12, 2017, the entire contents of which are hereby incorporated by reference

### FIELD OF TECHNOLOGY

The following relates to a spring sleeve for a piston cylinder unit, wherein the spring sleeve is adapted to receive a spring, at least partially, and guide it along a stroke path of the piston cylinder unit, wherein the spring sleeve has a cylindrical sleeve inner surface. The following further relates to a cylinder for a piston cylinder unit, wherein the cylinder is adapted to be arranged inside a spring of a piston cylinder unit. The following also relates to a piston cylinder unit, comprising a cylinder, a spring arranged concentrically around the cylinder, and an inner spring sleeve and outer spring sleeve each arranged concentrically around the spring, wherein the cylinder and the spring are arranged inside the inner spring sleeve and the outer spring sleeve. Finally, the following relates to a method of manufacturing such a piston cylinder unit.

### BACKGROUND

A piston cylinder unit of the aforesaid type is known from the known art, for example from DE 10 2005 007 741 A1. The piston cylinder unit comprises a central cylinder, around which two spring sleeves are arranged. A coil spring is supported and guided between the two spring sleeves, which partially engage in one another, and the cylinder. If the piston cylinder unit executes a stroke movement, the spring of the piston cylinder unit is compressed or decompressed along the stroke path by this.

In piston cylinder units of this kind, the diameter of the coil springs is enlarged upon compression of the coil spring and is reduced on decompression of the coil spring. The guide must thus have a certain tolerance, in order to avoid seizing of the coil spring and failure of the piston cylinder unit resulting therefrom. At the same time, however, a greater tolerance also increases the risk of “buckling” and inelastic deformation of the coil spring, due to which undesirable noises and/or damage to the cylinder or the spring sleeves can be caused.

To solve this problem, the piston cylinder unit described in DE 10 2005 007 741 A1 comprises a coil spring that has an elastic outer coating at least on its surface directed radially towards the cylinder wall. The coil spring is stabilized by this and a risk of damage to the friction partners (cylinder and spring sleeves) is reduced.

However, the aforesaid solution has the disadvantage that it regularly increases the friction and the wear between the spring and the friction partners. Added to this is the fact that the coated spring is difficult to manufacture, and thus significantly increases the costs of the piston cylinder unit.

Another problem of the known piston cylinder units is that, when using a lubricant between spring and friction partners to reduce the wear, the noise generated and the risk of seizing, a displacement or accumulation of the lubricant can occur due to a stroke movement, due to which the lubricating effect of the lubricant is limited.

### SUMMARY

An aspect relates to a low-cost spring sleeve for a piston cylinder unit, a cylinder for a piston cylinder unit, a piston cylinder unit and a manufacturing method of manufacturing such a piston cylinder unit, which facilitates reduced wear and improved movement characteristics of a piston cylinder unit.

A piston cylinder unit in the sense of embodiments of the invention can be, for example, a gas pressure spring or a pneumatic and/or hydraulic shock absorber.

### 1. Spring Sleeve

The first subject matter of embodiments of the present invention provides a spring sleeve for a piston cylinder unit of the type stated at the beginning, which achieves this aspect according to embodiments of the invention in that the spring sleeve has a number of one, two, three, four or more grooves on its sleeve inner surface.

According to embodiments of the invention, a “groove” is understood to mean an elongated indentation in a surface, which has a groove length along a longitudinal axis of the groove parallel to the surface that is substantially greater, for example at least twice, five times, ten times or a hundred times greater than a groove width of the groove orthogonally to the longitudinal axis and parallel to the surface.

The use of grooves in the sleeve inner surface initially has the effect that a smaller overall area of the spring sleeve is provided as friction partner with the spring to be guided, due to which friction and vibration transmission are reduced and possible noise generation is prevented. At the same time, however, virtually unchanged good guidance of the spring can be achieved.

Added to this is the fact that the grooves act as a reservoir for a lubricant used in the piston cylinder unit. By means of surface tension effects of the lubricant in particular, the grooves hold a portion of the lubricant, even if the remainder of the lubricant collects at the lower end of the piston cylinder unit due to gravity. The lubricating effect of the lubricant is improved by this, so that the service life and servicing intervals of the piston cylinder unit are extended. This effect can be optimized by coordinating the geometrical dimensions of the grooves to the lubricant.

When using the sleeve in the piston cylinder unit, the longitudinal axis of the grooves is advantageously oriented in an axial direction parallel to the stroke path. Such grooves are termed “axial grooves” according to embodiments of the invention. By orienting the longitudinal axis in an axial direction, better guidance of the spring is achieved than, for example, with an orientation of the longitudinal axis in a circumferential direction of the sleeve inner surface.

When using the sleeve in the piston cylinder unit, the groove length of the grooves advantageously corresponds to at least half of the sleeve spring length of the spring sleeve covered by the spring in a stroke movement of the piston cylinder unit, in particular to the entire sleeve spring length, or is greater than the sleeve spring length. It is ensured by such a groove length that the spring is optimally guided and lubricated over the entire stroke movement. If the groove length is greater than the sleeve spring length, the particular advantage results that additional lubricant reservoirs are formed outside the spring length, from which additional lubricant can reach the spring if required.

The spring sleeve according to embodiments of the invention can be an inner spring sleeve or an outer spring sleeve for a piston cylinder unit.

The axial grooves are evenly distributed in a circumferential direction around the sleeve inner surface, thus at a respective interval of 360°/2, 360°/3, 360°/4, 360°/5 etc. to the next adjacent groove, for example. For a better and more uniform pressure distribution and better guidance in the cylinder, above all relative to each unit of area, at least three grooves with the same angular distribution radially are provided.

The grooves have rounded edges at the transition to the remaining sleeve inner surface in a circumferential direction. Unnecessary friction effects and damage to a spring coating during turning of the spring coils against the spring sleeve can be avoided by this.

The grooves can have a constant depth in an axial direction. The depth of the groove is to be understood here as the radial distance of the deepest point of the groove from an imaginary ideal cylindrical sleeve inner surface. This embodiment permits a simple manufacture of the spring sleeve, for example by injection molding in one piece. At the same time, however, the constant depth of the grooves results in the lubricant still being able to flow easily along the grooves. The “reservoir” effect is thus still adaptable in this embodiment depending on geometry, so that an accumulation or displacement of the lubricant due to a stroke movement of the piston cylinder unit is prevented.

In one particular embodiment, the depth of the grooves varies along the axial direction. The depth of the grooves can vary periodically along the cylinder axis, for example. This embodiment has the advantage that the lubricant can be retained even better by the surface tension in the grooves, in particular the deepest regions. The “reservoir” effect is thus much more effective in this embodiment depending on geometry. On the other hand, this embodiment is more difficult to manufacture and in particular injection molding with grooves of varying depth in a sleeve inner surface in one piece is scarcely possible, due to which the manufacturing costs increase.

In another embodiment, the spring sleeve consists of a synthetic blend comprising plastics such as polyamide (PA) and in particular additions of polytetrafluoroethylene (PTFE), wherein the proportion of polytetrafluoroethylene is in the range of 10% to 30%, in particular 15% to 25%, especially around 20%, or of glass-fiber-reinforced polyamide.

It has proved to be the case that said materials for the spring sleeve have particularly advantageous characteristics as friction partners with the normal spring materials, such as an elastic steel, for example. Additions of polytetrafluoroethylene reduce the friction with the spring. In particular, trials have revealed that a share of approximately 20% of polytetrafluoroethylene leads to especially low friction over the entire product service life. Additions of fiber-reinforced polyamide make the spring sleeve more durable and reduce the wear by the spring. The reinforcing fibers can advantageously be glass fibers, carbon fibers and/or synthetic fibers.

In another embodiment, the spring sleeve comprises a cylindrical sleeve base layer and a sleeve surface layer, wherein the grooves are arranged in the sleeve surface layer, and wherein the sleeve base layer and the sleeve surface layer consist of different materials. The surface layer comprises a tribological coating to increase the surface hardness or the friction reduction, which both contribute to reducing the wear of the friction partners moved against one another.

This embodiment has the advantage that the sleeve base layer can consist of a particularly durable and stable material, for example of fiber-reinforced polyamide or a diamond-like carbon- and/or nitrogen-based coating (C—, CN—), while the sleeve surface layer can consist of a material with reduced friction with the spring, for example of a synthetic blend comprising polyamide (PA), in particular with additions of polytetrafluoroethylene. Furthermore, grooves of varying depth can also be realized more easily in this way. Thus the sleeve surface layer can be applied, for example, by an additive method to the inner surface of the sleeve base layer and in this process the grooves, of varying depth, can be introduced into the sleeve surface layer that is being formed.

### 2. Cylinder

An aspect according to embodiments of the invention is also achieved in a cylinder of the type stated at the beginning in that the cylinder has on its cylinder outer surface at least one groove, in particular two, three, four or more grooves.

The use of grooves in the cylinder outer surface initially has the effect here too that a smaller overall area of the spring sleeve is provided as a friction partner with the spring to be guided, due to which friction and vibration transmission are reduced and possible noise generation is prevented. At the same time, however, virtually unchanged good guidance of the spring can be achieved.

Added to this is the fact that the grooves act as a reservoir for a lubricant used in the piston cylinder unit. By means of surface tension effects of the lubricant in particular, the grooves hold a portion of the lubricant, even if the remainder of the lubricant collects at the lower end of the piston cylinder unit due to gravity. The lubricating effect of the lubricant is improved by this, so that the service life and servicing intervals of the piston cylinder unit are extended. This effect can be optimized by coordinating the geometrical dimensions of the grooves to the lubricant.

When using the cylinder in the piston cylinder unit, the longitudinal axis of the grooves is advantageously oriented in an axial direction parallel to the stroke path. Such grooves are termed “axial grooves” according to embodiments of the invention. By orienting the longitudinal axis in an axial direction, better guidance of the spring is achieved than, for example, with an orientation of the longitudinal axis in a circumferential direction of the cylinder outer surface.

When using the cylinder in the piston cylinder unit, the groove length of the grooves advantageously corresponds to at least half of the cylinder spring length of the cylinder covered by the spring in a stroke movement of the piston cylinder unit, in particular to the entire cylinder spring length. It is ensured by such a groove length that the spring is optimally guided and lubricated over the entire stroke movement.

The axial grooves are evenly distributed in a circumferential direction around the cylinder outer surface, thus for example at a respective interval of 360°/2, 360°/3, 360°/4, 360°/5 etc. to the next adjacent groove. For a better and more uniform pressure distribution and better guidance in the cylinder, above all relative to each unit of area, at least three grooves with the same angular distribution radially are provided.

The grooves have rounded edges at the transition to the remaining cylinder outer surface in a circumferential direction. Unnecessary friction effects and damage to a spring coating during turning of the spring coils against the cylinder can be avoided by this.

The grooves can have a constant depth in an axial direction. The depth of the groove is to be understood here as the radial distance of the deepest point of the groove from an imaginary ideal cylindrical cylinder outer surface. This embodiment permits a simple manufacture of the cylinder. At the same time, however, the constant depth of the grooves results in the lubricant still being able to flow easily along the grooves. The “reservoir” effect is thus still adaptable in this embodiment depending on geometry, so that an accumulation or displacement of the lubricant due to a stroke movement of the piston cylinder unit is prevented.

The “cylinder” as a component in the context of this application is usually not ideally cylindrical, but has at least a cylindrical outer surface.

In one particular embodiment, the depth of the grooves varies along the axial direction. The depth of the grooves can vary periodically along the cylinder axis, for example. This embodiment has the advantage that the lubricant can be retained even better by the surface tension in the grooves, in particular the deepest regions. The “reservoir” effect is thus much more effective in this embodiment depending on geometry. On the other hand, this embodiment is more difficult to manufacture, in particular by injection molding in one piece of a cylinder with grooves of varying depth on a cylinder outer surface, due to which the manufacturing costs increase.

In another embodiment, the cylinder comprises a cylindrical cylinder base layer and a cylinder surface layer, wherein the grooves are arranged in the cylinder surface layer, and wherein the cylinder base layer and the cylinder surface layer consist of different materials.

This embodiment has the advantage that the cylinder base layer can consist of a particularly durable and stable material, for example of glass-fiber-reinforced polyamide, while the cylinder surface layer can consist of a material with reduced friction with to the spring, for example of a synthetic blend comprising polyamide (PA), in particular with additions of polytetrafluoroethylene. Furthermore, grooves of varying depth can also be realized more easily in this way. Thus the cylinder surface layer can be applied, for example, by an additive method to the outer surface of the cylinder base layer and in this process the grooves, of varying depth, can be introduced into the cylinder surface layer that is being formed.

### 3. Piston Cylinder Unit

An aspect according to embodiments of the invention is also achieved in a piston cylinder unit of the type stated at the beginning in that the inner spring sleeve and/or the outer spring sleeve and/or the cylinder has, on a surface facing the spring, at least one groove, in particular two, three, four or more grooves.

According to embodiments of the invention, grooves can thus be arranged in one, two or all three said parts of the piston cylinder unit. The use of grooves initially has the effect here too that a smaller overall area of the spring sleeve is provided as friction partner with the spring to be guided, due to which friction and vibration transmission are reduced and possible noise generation is prevented. At the same time, however, virtually unchanged good guidance of the spring can be achieved.

Added to this is the fact that the grooves act as a reservoir for a lubricant used in the piston cylinder unit. By means of surface tension effects of the lubricant in particular, the grooves hold a portion of the lubricant, even if the remainder of the lubricant collects at the lower end of the piston cylinder unit due to gravity. The lubricating effect of the lubricant is improved by this, so that the service life and servicing intervals of the piston cylinder unit are extended. This effect can be optimized by coordinating the geometrical dimensions of the grooves to the lubricant.

The grooves are arranged on a surface facing the spring at least of the inner spring sleeve and more also of the cylinder. Reduced friction and good lubrication of the spring can thus be achieved even after a long resting phase of the piston cylinder unit.

The longitudinal axis of the grooves is advantageously oriented in an axial direction parallel to the stroke path. Such grooves are termed “axial grooves” according to embodiments of the invention. By orienting the longitudinal axis in an axial direction, better guidance of the spring is achieved than, for example, with an orientation of the longitudinal axis in a circumferential direction of the sleeve inner surface or cylinder outer surface.

The groove length of the grooves advantageously corresponds to at least half of the sleeve spring length of the spring sleeve or cylinder spring length of the cylinder covered by the spring in a stroke movement of the piston cylinder unit, in particular to the overall sleeve spring length or cylinder spring length, or is greater than the sleeve spring length or cylinder spring length. It is ensured by such a groove length that the spring is optimally guided and lubricated over the entire stroke movement. If the groove length is greater than the sleeve spring length or cylinder spring length, the particular advantage results that additional lubricant reservoirs are formed outside the spring length, from which additional lubricant can reach the spring if required.

The axial grooves are evenly distributed in a circumferential direction around the sleeve inner surface(s) of the inner spring sleeve and/or the outer spring sleeve and/or the cylinder outer surface of the cylinder, thus at a respective interval of 360°/2, 360°/3, 360°/4, 360°/5 etc. to the next adjacent groove, for example. For a better and more uniform pressure distribution and better guidance in the cylinder, above all relative to each unit of area, at least three grooves with the same angular distribution radially are provided.

The grooves have rounded edges at the transition to the remaining sleeve inner surface or cylinder outer surface in a circumferential direction. Unnecessary friction effects and damage to a spring coating during turning of the spring coils against the spring sleeve(s) or the cylinder can be avoided by this.

The grooves can have a constant depth in an axial direction. The depth of the groove is to be understood here as the radial distance of the deepest point of the groove from an imaginary ideal cylindrical sleeve inner surface or an imaginary ideal cylindrical outer surface of the cylinder. This embodiment permits a simple manufacture of the spring sleeve or cylinder, for example by injection molding in one piece. At the same time, however, the constant depth of the grooves results in the lubricant still being able to flow easily along the grooves. The “reservoir” effect is thus still adaptable in this embodiment depending on geometry, so that an accumulation or displacement of the lubricant due to a stroke movement of the piston cylinder unit is prevented.

In one embodiment, the depth of the grooves varies along the axial direction. The depth of the grooves can vary periodically along the cylinder axis, for example. This embodiment has the advantage that the lubricant can be retained even better by the surface tension in the grooves, in particular the deepest regions. The “reservoir” effect is thus much more effective in this embodiment depending on geometry. On the other hand, this embodiment is more difficult to manufacture, and in particular injection molding in one piece is scarcely possible, due to which the manufacturing costs increase.

All features described with reference to the embodiments of the spring sleeve for a piston cylinder unit and of the cylinder for a piston cylinder unit are also claimed individually and in any combinations with regard to the piston cylinder unit according to embodiments of the invention.

The spring is not flocked in one embodiment. In the known art, the springs in piston cylinder units are flocked at least over a friction section, in order to minimize the noise generation and nevertheless achieve a stable mounting of the spring. However, a flocked spring would partly reduce or cancel out the effect of the grooves in embodiments of the present invention, as the flocked fibers would also rub in the grooves with the friction partner (spring sleeve(s) and/or cylinder) and on the other hand would remove any lubricant used from the “reservoirs” in the grooves.

In one particular embodiment, at least one surface of the inner spring sleeve and/or the outer spring sleeve and/or the cylinder is friction-optimized with regard to the material of the spring, by the choice of material of a cylinder surface layer of the cylinder and/or of a sleeve surface layer of the inner spring sleeve and/or the outer spring sleeve.

For example, it has turned out that a sleeve surface layer and/or a cylinder surface layer from a synthetic blend comprising polyamide and additions of polytetrafluoroethylene, wherein the proportion of polytetrafluoroethylene is in a range of 10% to 30%, in particular of 15% to 25%, is in particular around 20%, has advantageous friction characteristics with regard to a spring of e.g. spring steel.

### 4. Manufacturing Method for a Piston Cylinder Unit

An aspect of embodiments of the invention is also achieved by a method of manufacturing a piston cylinder unit, comprising:
a cylinder,
   a spring arranged concentrically around the cylinder,
   an inner spring sleeve and outer spring sleeve each arranged concentrically around the spring, wherein the method includes the steps:
introduction of grooves into:
   the inner spring sleeve and/or
   the outer spring sleeve and/or
   the cylinder
on a surface facing the spring, by injection molding, an additive method or a subtractive method.

With the manufacturing method according to embodiments of the invention, a piston cylinder unit according to embodiments of the invention with the advantages described above can be obtained. The grooves can thus be introduced into one, two or all three named parts of the piston cylinder unit, at least into the inner spring sleeve. The use of grooves here also initially has the effect that a smaller overall area of the spring sleeve is provided as friction partner with the spring to be guided, due to which friction and vibration transmission are reduced and possible noise generation is prevented. At the same time, however, virtually unchanged good guidance of the spring can be achieved.

The longitudinal axis of the grooves is advantageously oriented following mounting of the piston cylinder unit in an axial direction parallel to the stroke path. Such grooves are termed “axial grooves” according to embodiments of the invention. By orienting the longitudinal axis in an axial direction, better guidance of the spring is achieved than, for example, with an orientation of the longitudinal axis in a circumferential direction of the sleeve inner surface or the cylinder outer surface.

The groove length of the grooves advantageously corresponds to at least half of the sleeve spring length of the spring sleeve or cylinder spring length of the cylinder covered by the spring in a stroke movement of the piston cylinder unit, in particular to the entire sleeve spring length or cylinder spring length, or is greater than the sleeve spring length or cylinder spring length. It is ensured by such a groove length that the spring is optimally guided and lubricated over the entire stroke movement. If the groove length is greater than the sleeve spring length or cylinder spring length, the particular advantage results that additional lubricant reservoirs are formed outside the spring length, from which additional lubricant can reach the spring if required.

In one particular embodiment, the grooves are introduced with a depth varying along the axial direction. This embodiment delivers, as already described above, an improved reservoir effect with regard to any lubricant to be introduced into the grooves. However, it is difficult to introduce such grooves into the inner surface of the spring sleeve(s).

Alternatively to the previous embodiment, the grooves can also be introduced with a constant depth. This has the advantage that the manufacture, in particular of the spring sleeves, is simpler. An introduction of grooves of variable depth into the inner surface of the sleeves is difficult, in particular if the sleeves are to be manufactured in one piece.

In another embodiment, the method comprises the step of producing the inner spring sleeve and/or the outer spring sleeve by coating a cylindrical sleeve base layer with a sleeve surface layer, wherein the grooves are introduced into the sleeve surface layer. In this embodiment it is easier to introduce the grooves with a varying depth in an axial direction. Furthermore, the material of the sleeve base layer(s) can be selected to be as stable as possible, while the material of the sleeve surface layer(s) can be optimized with regard to the friction with the spring, i.e. a tribological coating can be used.

In one embodiment, the method comprises the step of producing the cylinder by coating a cylindrical cylinder base layer with a cylinder surface layer, wherein the grooves are introduced into the cylinder surface layer. In this embodiment it is simpler to introduce the grooves with a varying depth in an axial direction. Furthermore, the material of the cylinder base layer(s) can be selected to be as stable as possible, while the material of the cylinder surface layer(s) can be optimized with regard to the friction with the spring, i.e. a tribological coating can be used.

Other advantages, objects and properties of embodiments of the present invention are explained by means of the following description and attached drawings, in which embodiments of the invention are depicted by way of example. Components, which correspond in the figures at least substantially in respect of their function, can be characterized in this case by the same reference numbers, wherein these components do not have to be numbered and explained in all figures.

### BRIEF DESCRIPTION

Some of the embodiments will be described in detail, with reference to the following figures, wherein like designations denote like members, wherein:

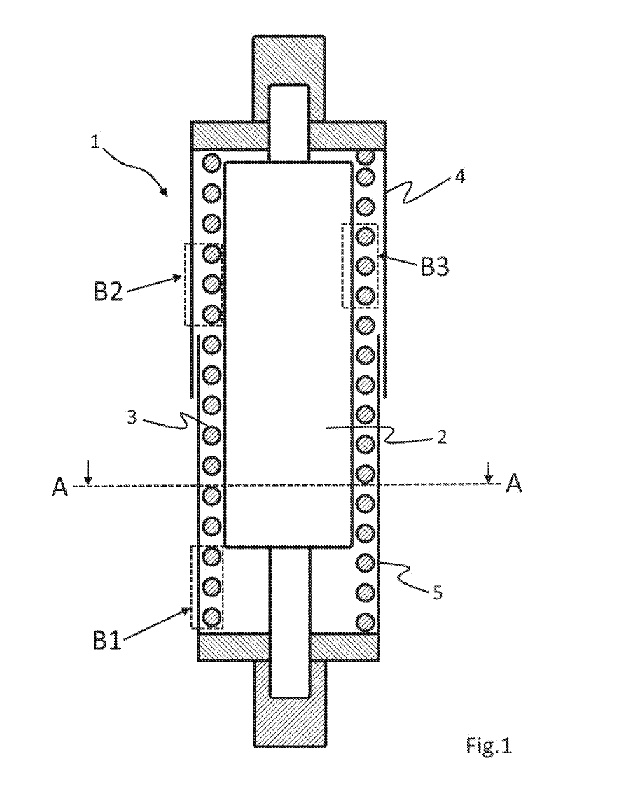

FIG. 1 a schematic sectional view of a piston cylinder unit as well as a spring sleeve and a cylinder;

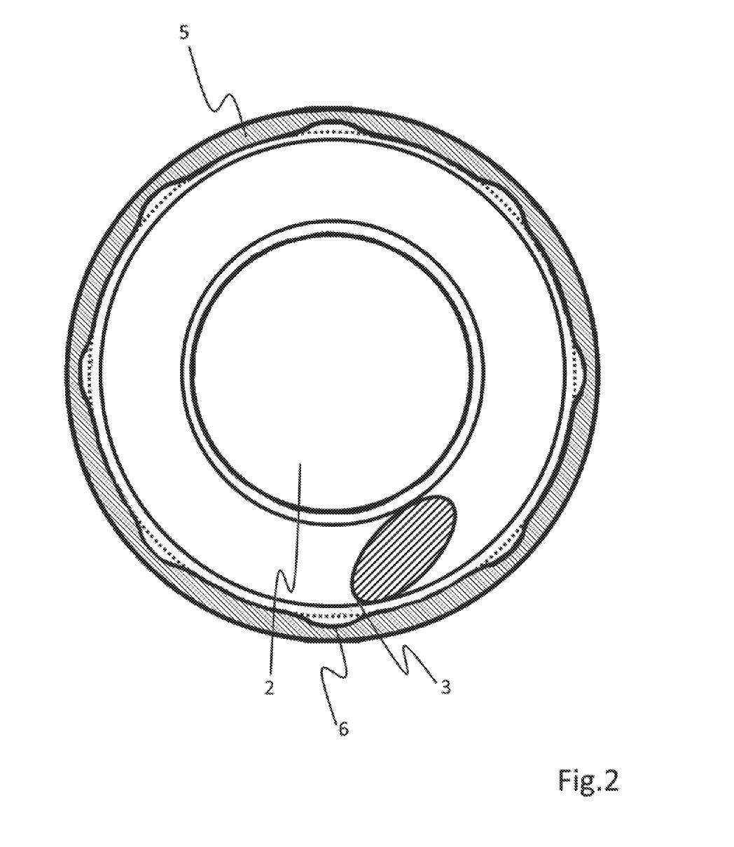

FIG. 2 a sectional view along the plane A-A of FIG. 1 of a piston cylinder unit;

FIG. 3 a schematic sectional view of the section B1, B2 or B3 from FIG. 1 in a first embodiment;

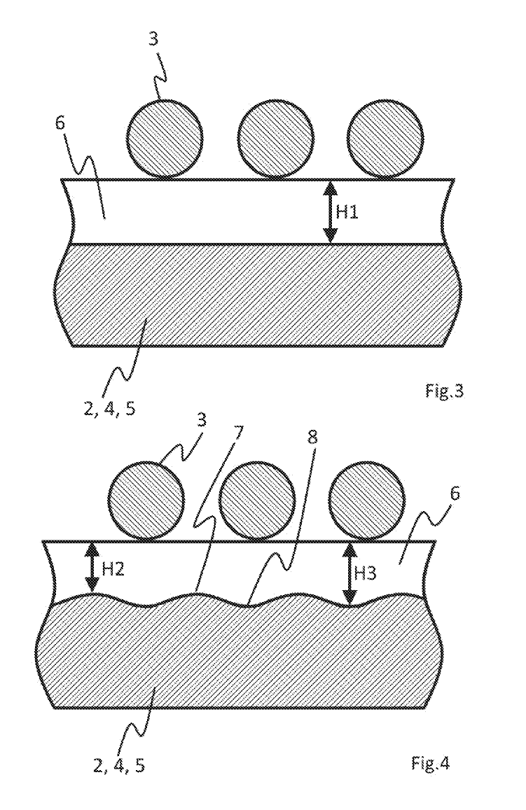

FIG. 4 a schematic sectional view of the section B1, B2 or B3 from FIG. 1 in a second embodiment;

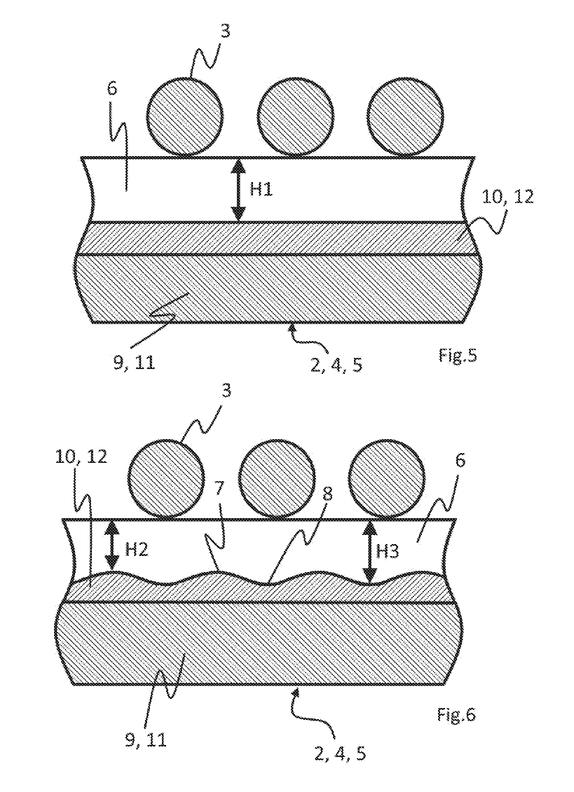

FIG. 5 a schematic sectional view of the section B1, B2 or B3 from FIG. 1 in a third embodiment; and

FIG. 6 a schematic sectional view of the section B1, B2 or B3 from FIG. 1 in a fourth embodiment.

### DETAILED DESCRIPTION

FIG. 1 shows a schematic sectional view of a piston cylinder unit 1 according to embodiments of the invention, comprising a cylinder 2, a spring 3, an outer spring sleeve 4 and an inner spring sleeve 5. The two spring sleeves 4, 5 are arranged concentrically around the centrally arranged cylinder 2. The spring 3 is supported and guided between the two spring sleeves 4, 5 partially engaging in one another and the cylinder 2. The outer spring sleeve 4 has a larger inner diameter than the outer diameter of the inner spring sleeve 5, due to which the inner spring sleeve 5 can penetrate further into the outer spring sleeve 4 in the event of loading of the piston cylinder unit 1.

In the inside of the cylinder 2, there can be arranged, for example, a gas pressure spring, or the cylinder 2 can be part of a gas pressure spring. The cylinder 2 can also consist of several cylinder segments, which can partially penetrate into one another, in order to shorten or lengthen the cylinder 2. The cylinder 2 is therefore depicted here in one piece purely for the sake of simplicity.

FIG. 2 shows a sectional view along the section plane A-A in FIG. 1. Here only one embodiment of the invention is shown as an example, which only has axial grooves 6 in the inner spring sleeve 5.

The axial grooves in the sleeve inner surface reduce the overall area of the spring sleeve that is provided as friction partner with the spring 3 to be guided. The spring 3 is represented here by a circular ring with a hatched section, in order to clarify the reduction in the friction area with the inner spring sleeve 5. The dotted lines represent the contour of an alternative inner spring sleeve 5 without axial grooves 6.

The axial grooves 6 also serve as a reservoir for a lubricant used in the piston cylinder unit 1. By means of surface tension effects of the lubricant, the grooves 6 hold a portion of the lubricant, even if the remainder of the lubricant collects at the lower end of the piston cylinder unit 1 due to gravity. This effect can be optimized by coordination of the geometrical dimensions of the grooves to the lubricant.

FIGS. 3-6 show simplified schematic sectional views of the plane regions B1, B2 and B3 of FIG. 1. The structures depicted can thus correspond to the contact region between the spring 3 and the inner spring sleeve 5 (B1) or the spring 3 and the outer spring sleeve 4 (B2) or the spring 3 and the cylinder 2 (B3).

FIG. 3 shows a schematic sectional view of a contact region between the spring 3 and the surface of one of the spring sleeves 4, 5 or of the cylinder 2 in the area of an axial groove 6. As is recognizable, the spring 3 is in contact with the friction partner outside the groove area, while in the area shown it is not in direct contact. The overall surface of the spring sleeve 4, 5 or of the cylinder 2 that is available as friction partner with the spring 3 is thus reduced. A lubricant can be introduced, furthermore, into the axial grooves 6. The grooves then act as a reservoir for the lubricant and prevent the lubricant from collecting completely at one end of the piston cylinder unit 1 when the piston cylinder unit is inactive for a long time. The axial groove 6 in this embodiment has a constant depth H1 along the axial direction (in a horizontal direction in each case in FIGS. 3-6).

FIG. 4 shows another schematic sectional view of a contact region between the spring 3 and the surface of one of the spring sleeves 4, 5 or of the cylinder 2 in the area of an axial groove 6. In contrast to the previous embodiment, the axial groove 6 has a varying depth in an axial direction here. The depth of the groove 6 varies between a smallest depth H2 at a groove maximum 7 and a greatest depth H3 at a groove minimum 8. The axial groove 6 in this embodiment has a periodically varying depth, for example with a sinusoidal profile.

FIG. 5 shows yet another schematic sectional view of a contact region between the spring 3 and the surface of one of the spring sleeves 4, 5 or of the cylinder 2 in the area of an axial groove 6. As in FIG. 3, the axial groove 6 in this embodiment has a constant depth H1.

The spring sleeve(s) 4, 5 and/or the cylinder 2 have at least two layers in this embodiment, however.

The outer spring sleeve 4 and/or the inner spring sleeve 5 has a sleeve base layer 9 and a sleeve surface layer 10 and/or the cylinder has a cylinder base layer 11 and a cylinder surface layer 12.

The axial groove 6 is arranged completely in the sleeve surface layer 10 or the cylinder surface layer 12. The axial groove 6 can be introduced, for example, when applying the sleeve surface layer 10 or the cylinder surface layer 12 to the respective base layer 9, 11.

The respective base layer 9, 11 can consist of a mechanically particularly durable and stable material, for example of glass-fiber-reinforced polyamide. The respective surface layer 10, 12 can consist of a material with reduced friction relative to the material of the spring 3 (for example, spring steel), for example of a synthetic blend comprising polyamide and additions of polytetrafluoroethylene.

FIG. 6 shows yet another schematic sectional view of a contact region between the spring 3 and the surface of one of the spring sleeves 4, 5 or of the cylinder 2 in the area of an axial groove 6. Like in the embodiment in FIG. 4, the axial groove 6 has a varying depth in an axial direction here. The depth of the groove 6 varies between a smallest depth H2 at a groove maximum 7 and a greatest depth H3 at a groove minimum 8.

The spring sleeve(s) 4, 5 and/or the cylinder 2 in this embodiment have at least two layers, as was the case in the embodiment in FIG. 5.

The outer spring sleeve 4 or the inner spring sleeve 5 have a sleeve base layer 9 and a sleeve surface layer 10, or the cylinder has a cylinder base layer 11 and a cylinder surface layer 12. The corresponding also applies here as for FIG. 5 with regard to the choice of material.

The axial groove 6 in this embodiment has a periodically varying depth, for example with a sinusoidal profile.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

### REFERENCE SIGN LIST

1 Piston cylinder unit

### 2 Cylinder

### 3 Spring

4 Outer spring sleeve
5 Inner spring sleeve

### 6 Groove

7 Groove maximum
8 Groove minimum
9 Sleeve base layer
10 Sleeve surface layer
11 Cylinder base layer
12 Cylinder surface layer

1. A spring sleeve for a piston cylinder unit, wherein the spring sleeve is adapted to receive a spring, at least partially, and to guide it along a spring path of the piston cylinder unit, wherein the spring sleeve comprises a cylindrical sleeve inner surface, wherein
a. the spring sleeve comprises a number of grooves on its sleeve inner surface, and
b. a longitudinal axis of the grooves is oriented in an axial direction parallel to the stroke path of the piston cylinder unit,
wherein
c. the depth of the grooves varies along the axial direction.

2. The spring sleeve according to claim 1,
wherein the spring sleeve having a synthetic blend comprising a plastic of polyamide, and additions
of polytetrafluoroethylene, wherein the proportion of polytetrafluoroethylene lies in a range of 10% to 30%,
or
of polyamide fiber-reinforced with carbon fibers, glass fibers and/or plastic fibers.

3. The spring sleeve according to claim 1,
wherein
the spring sleeve comprises a cylindrical sleeve base layer and a sleeve surface layer, wherein the grooves are arranged in the sleeve surface layer, and wherein the sleeve base layer and the sleeve surface layer consist of different materials.

4. A cylinder for a piston cylinder unit, wherein the cylinder is adapted to be arranged inside a spring of a piston cylinder unit, wherein
a. the cylinder has a number of grooves on its cylinder outer surface, and
b. a longitudinal axis of the grooves is oriented in an axial direction parallel to a stroke path of the piston cylinder unit,
wherein
c. the depth of the grooves varies along the axial direction.

5. The cylinder according to claim 4,
wherein
the cylinder comprises a cylindrical cylinder base layer and a cylinder surface layer, wherein the grooves are arranged in the cylinder surface layer, and wherein the cylinder base layer and the cylinder surface layer includes different materials.

6. A piston cylinder unit, comprising:
a cylinder,
a spring arranged concentrically around the cylinder,
an inner spring sleeve and an outer spring sleeve each arranged concentrically around the spring, wherein the cylinder and the spring are arranged inside the inner spring sleeve and the outer spring sleeve, and
the inner spring sleeve and/or
the outer spring sleeve and/or
the cylinder has a number of grooves on the surface facing the spring, wherein a longitudinal axis of the grooves is oriented in an axial direction parallel to a stroke path of the piston cylinder unit,
wherein
the depth of the grooves varies along the axial direction.

7. The piston cylinder unit according to claim 6,
wherein
at least one surface
of the inner spring sleeve and/or
the outer spring sleeve and/or
the cylinder is friction-optimized with respect to the material of the spring by the material choice of a cylinder surface layer of the cylinder and/or of a sleeve surface layer of the inner spring sleeve and/or of a sleeve surface layer of the outer spring sleeve.

8. A method of manufacturing a piston cylinder unit, comprising:
a cylinder,
a spring arranged concentrically around the cylinder,
an inner spring sleeve and an outer spring sleeve each arranged concentrically around the spring, comprising by the following steps:
introduction of a number of grooves into:
the inner spring sleeve and/or
the outer spring sleeve and/or
the cylinder on a surface facing the spring, by injection molding, an additive method or a subtractive method, wherein the grooves are introduced with a longitudinal axis oriented in an axial direction parallel to a stroke path of the piston cylinder unit,
wherein the grooves are introduced with a depth varying along the axial direction.

9. The method according to claim 8,
having the following step:
production of the inner spring sleeve and/or the outer spring sleeve by coating a cylindrical sleeve base layer with a sleeve surface layer, wherein the grooves are introduced into the sleeve surface layer.

10. The method according to claim 8,
having the following step:
production of the cylinder by coating a cylindrical cylinder base layer with a cylinder surface layer, wherein the grooves are introduced into the cylinder surface layer.
